(19) United States
(12) Patent Application Publication
(10) Pub. No.: US 2011/0003550 A1
(43) Pub. Date: Jan. 6, 2011

(54) TACTILE INPUT FOR ACCESSORIES

(75) Inventors: Gunnar KLINGHULT, Lund (SE); Simon LESSING, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/534,473

(22) Filed: Aug. 3, 2009

Related U.S. Application Data
(60) Provisional application No. 61/223,009, filed on Jul. 3, 2009.

(51) Int. Cl. H04B 7/00; G08B 6/00

(52) U.S. Cl. 455/41.3; 340/407.2; 455/550.1

(57) ABSTRACT

A device includes multiple textured surfaces associated with functions of the device, and vibration sensors coupled to the textured surfaces. The device also includes a signal analyzer to analyze a signal received from the vibration sensors and determine which of the one or more textured surfaces is associated with the analyzed signal. The device further includes a function selector to select the function associated with the textured surface, based on the analyzed signal.

### RELATED APPLICATION

This application claims priority under 35 U.S.C. §119 based on U.S. Provisional Application No. 61/223,009, filed Jul. 3, 2009, the disclosure of which is hereby incorporated herein by reference.

### BACKGROUND

Many electronic devices provide functions that may be activated through user input. For example, a portable electronic device may play audio or video files, such as music tracks or video clips. Functions of the portable electronic device may include playing or stopping a track, skipping forward or backward within a track, or raising or lowering the volume of the track. A user may control such functions through an input device, which may consist of buttons provided on the surface of the portable communication device. A user may need to provide input to an electronic device without holding the electronic device or without looking at the electronic device. Furthermore, many electronic devices, such as mobile communication devices, have limited input and output capabilities due to their relatively small sizes. For example, many mobile communication devices have small visual displays and limited numbers of keys for user input. Given the increasing array of features included in mobile communication devices, the limited ability to interact with mobile communication devices can be increasingly troublesome.

### SUMMARY

According to one aspect, a device may include one or more textured surfaces, where each of the one or more textured surfaces is associated with a particular function performed by the device, one or more vibration sensors coupled to the one or more textured surfaces, a signal analyzer, coupled to the one or more vibration sensors, to analyze a signal received from the one or more vibration sensors, and determine which particular one of the one or more textured surfaces is associated with the analyzed signal, and a function selector to select the particular function associated with the particular one of the one or more textured surfaces, based on the analyzed signal.

Additionally, the device may include a communication cable and the one or more textured surfaces may be located on the communication cable.

Additionally, each of the one or more textured surfaces may include a different pattern, and scratching or rubbing each of the one or more textured patterns may produce a different vibration waveform.

Additionally, at least one of the one or more textured surfaces may include a pattern that produces a first vibration waveform when the pattern is scratched or rubbed in a first direction and may produce a second vibration waveform when the pattern is scratched or rubbed in a second direction.

Additionally, the device may be an accessory device of a mobile communication device.

Additionally, the accessory device may be at least one of a stand-alone earpiece with or without a microphone, headphones with or without a microphone, a Bluetooth wireless headset, a cable for connecting to an accessory input in a vehicle, a charging cable, a portable speaker, a camera, a video recorder, a frequency modulated (FM) radio, a universal serial bus (USB) port charging and synchronization data cable, an accessory keyboard, or a microphone.

Additionally, the signal analyzer component may be further to calculate at least one value associated with the signal.

Additionally, the at least one value may include at least one of a speed with which one of the one or more textured surfaces was scratched or rubbed, a pressure with which one of the one or more textured surfaces was scratched or rubbed, or a direction in which one of the one or more textured surfaces was scratched or rubbed.

Additionally, the particular function may include at least one of volume control, skipping forward or backward in an audio or video track, skipping to a next audio or video track or skipping to a previous audio or video track, or playing and stopping an audio or video track.

Additionally, the particular function may include volume control, and scratching or rubbing the particular one of the one or more textured surfaces in a first direction may increase the volume, and scratching or rubbing the particular one of the one or more textured surfaces in a second direction may decrease the volume.

Additionally, the particular function may include volume control, and at least one of a pressure or speed with which the particular one of the textured surfaces is scratched or rubbed may determine a degree of volume change.

Additionally, the one or more textured surfaces may represent an identification code that identifies the device.

Additionally, the one or more vibration sensors may include at least one of a microphone, an accelerometer, or a piezoelectric sensor.

According to another aspect, a method, performed by an electronic device, may include receiving, by one or more sensors associated with the electronic device, a vibration signal from one or more textured surfaces, analyzing, by a processor of the electronic device, the received signal, determining, by the processor, a particular one of the one or more textured surfaces associated with the received signal, selecting, by the processor, a particular function assigned to the particular one of the one or more textured surfaces.

Additionally, the method may further include calculating at least one value associated with the received signal.

Additionally, the at least one value may represent at least one of a speed with which one of the one or more textured surfaces was scratched or rubbed, a pressure with which one of the one or more textured surfaces was scratched or rubbed, or a direction in which one of the one or more textured surfaces was scratched or rubbed.

Additionally, the particular function may include at least one of volume control, skipping forward or backward in an audio or video track, skipping to a next audio or video track or skipping to a previous audio or video track, playing and stopping an audio or video track, controlling a brightness of a screen of the electronic device, zooming in or out of contents displayed on the screen, zooming in and out of focus with a camera of the electronic device, scrolling through contents of the screen or through a list of selectable objects, simulating a single click of a pointing device, simulating a double-click of the pointing device, selecting a hyperlink, moving a cursor across a screen, entering characters, dialing a number or hanging up a call, canceling an action, highlighting an object on the screen, selecting an object on the screen, turning a page of a virtual book, or controlling a character or an element in a game.

Additionally, the method may further include receiving, by the one or more sensors, a second vibration signal from one or more second textured surfaces of a second electronic device, and the analyzing may further include analyzing the second vibration signal.

Additionally, the method may further include performing an identification or synchronization operation associated with the electronic device and the second electronic device, based on the analyzed signal.

According to yet another aspect, a system may include means for assigning a different function to each of a set of textured surfaces located on a communication cable associated with the system, where each of the set of textured surfaces comprises a different pattern, means for receiving a vibration signal from the set of textured surfaces, means for determining which particular one of the set of textured surfaces generated the vibration signal, means for determining at least one of a direction, a speed, or a pressure associated with a motion that generated the vibration signal, and means for selecting the function assigned to the particular one of the set of textured surfaces and for selecting a value associated with the selected function based on the at least one of a direction, a speed, or a pressure.

### BRIEF DESCRIPTION OF THE DRAWINGS

The accompanying drawings, which are incorporated in and constitute a part of this specification, illustrate one or more systems and/or methods described herein and, together with the description, explain these systems and/or methods. In the drawings:

FIG. 1 is a diagram of an exemplary mobile communication device and an exemplary accessory device in which systems and/or methods described herein may be implemented;

FIG. 2 is a diagram illustrating exemplary components of the mobile communication device of FIG. 1;

FIG. 3 illustrates a portion of the exemplary accessory device depicted in FIG. 1 in more detail;

FIG. 4A illustrates an exemplary input device of the accessory device depicted in FIG. 3;

FIG. 4B illustrates another exemplary input device of the accessory device depicted in FIG. 3;

FIG. 5 illustrates exemplary components of a tactile input device implemented in the accessory device depicted in FIG. 3;

FIG. 6 is a flow diagram illustrating a process for detecting tactile input according to an exemplary implementation;

FIG. 7 is a first example of a tactile input device according to implementations described herein;

FIG. 8 is a second example of a tactile input device according to implementations described herein;

FIG. 9 is a diagram of the mobile communication device of FIG. 1 equipped with a tactile input device according to implementations described herein; and

FIG. 10 is a flow diagram illustrating a process for detecting tactile input from a mobile communication device and an accessory device according to an exemplary implementation.

### DETAILED DESCRIPTION

The following detailed description refers to the accompanying drawings. The same reference numbers in different drawings identify the same or similar elements. Also, the following detailed description does not limit the invention.

Systems and/or methods described herein may relate to a tactile input device for electronic devices. The tactile input device may include one or more textured surfaces, and each of the one or more textured surfaces may provide for a separate source of input. A user may provide input by scratching, rubbing, or otherwise contacting one or more of the textured surfaces. The scratching or rubbing action may produce vibrations, which may be detected by one or more sensors. Each of the textured surfaces may produce unique vibration waveforms. A signal analyzer component, coupled to the one or more sensors, may receive signals from the one or more sensors and may determine which particular surface was contacted by analyzing the received signals. The textured surfaces may be provided, for example, on a communication cable of an accessory device of a mobile phone. By scratching or rubbing different areas of the cable, a user may activate different functions, such as, for example, increasing or decreasing volume, skipping forward or backward in an audio or video track, or skipping to the next or previous track. Moreover, the signal analyzer component may determine values of various parameters associated with the scratching or rubbing motion, such as a speed, pressure, and direction of the motion, and may associate the values with the function. For example, if a user scratches a textured surface in one direction, the volume may increase, and if the user scratches in the opposite direction, the volume may decrease. Furthermore, if a user scratches slowly, the volume may change slightly, and if the user scratches faster, the volume may change to a greater degree.

A series of textured surfaces may also be used as an identification code for device identification or synchronization. When a user scratches, rubs, or otherwise contacts the series of textured surfaces, a unique series of vibrations may be produced that may be interpreted as an identification code and used to identify a device or synchronize the device with another device.

The tactile input device described herein may provide an input device in an area not previously utilized for input (e.g., by electronic devices). Such an input device may be provided in small portable electronic devices that have limited surface area for input. The tactile input device described herein may provide an input device within easy access of a user's hand during normal activity. For example, if a user is walking down the street, the user does not have to pull out a portable electronic device out of a pocket to activate a function, such as increasing the volume of a speaker. Rather, the user may simply scratch an area of an exposed cord of an earpiece to increase the volume.

Furthermore, by providing textured surfaces on a cord, a user may receive proprioceptive feedback while providing input. In contrast, existing input devices may include flat buttons or touch screens that do not provide tactile feedback to a user. For example, when a user presses a flat button, unless the user is looking at the device on which the button is located, the user may not be able to tell which button the user is pressing. The tactile device described herein may provide different textured surfaces, allowing a user to recognize by touch which particular function the user is activating.

Exemplary implementations described herein may be described in the context of a mobile communication device (or mobile terminal). A mobile communication device is an example of a device that may be connected to a tactile input device described herein, and should not be construed as limiting of the types or sizes of devices or applications that can include the tactile input device described herein. For example, the tactile input devices described herein may be used with a desktop device (e.g., a personal computer or workstation), a laptop computer, a personal digital assistant (PDA), a media playing device (e.g., an MPEG audio layer 3 (MP3) player, a digital video disc (DVD) player, a video game playing device), a household appliance (e.g., a microwave oven and/or appliance remote control), an automobile radio faceplate, a television, a computer screen, a point-of-sale terminal, an automated teller machine, an industrial device (e.g., test equipment, control equipment), or any other device that may utilize an input device.

An electronic device may include a communication cable. The communication cable may include an electrical cord (i.e. one or more wires surrounded by insulation) for electronically connecting the electronic device to another electronic device, to a power supply, to an input device, or to an output device. For example, an accessory device may provide additional functionality to a mobile communication device. The accessory device may include a cord that connects the accessory device to the mobile communication device or to an input or output device of the accessory device, such as an earpiece. The accessory device may include, for example, a stand-alone earpiece with or without a microphone, headphones with or without a microphone, a Bluetooth wireless headset, a cable for connecting to an accessory input in a vehicle, a charging cable, a portable speaker, a camera, a video recorder, an frequency modulated (FM) radio, a Universal Serial Bus (USB) port charging and synchronization data cable, an accessory keyboard, a microphone, or other accessory devices. The communication cable may include an optical cable for transmitting optical signals.

While exemplary implementations described herein may be described in the context of an accessory device for a mobile communication device, it is to be understood that the tactile input device described herein may be implemented in any electronic device that requires user input. Furthermore, while the tactile input device described herein may be described in the context of a cord, this should not be construed as limiting the tactile input device to being implemented on a cord. For example, the tactile input device may be implemented on any surface of an electronic device, such as the housing of the electronic device.

### Exemplary Device

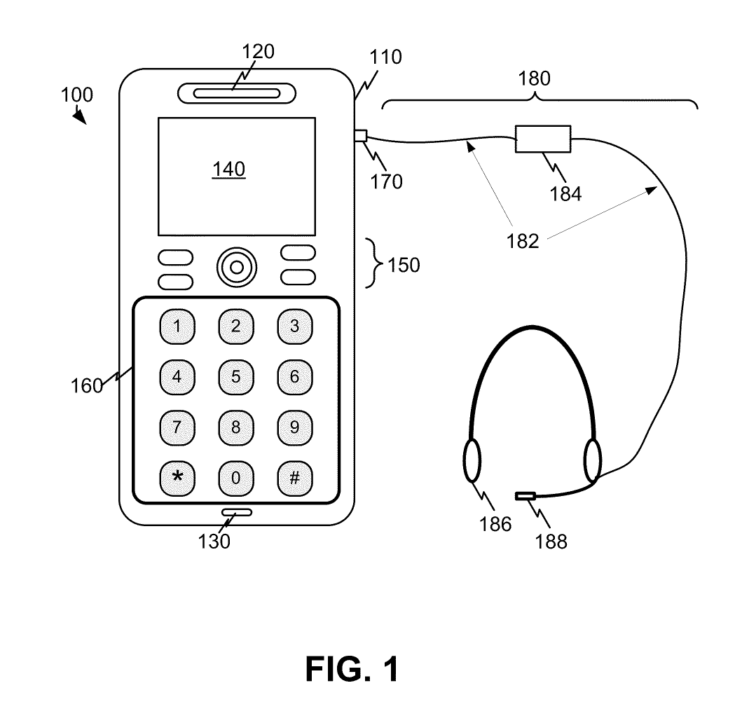

FIG. 1 is a diagram of an exemplary mobile communication device 100 in which systems and/or methods described herein may be implemented. As shown, mobile communication device 100 may include a cellular radiotelephone with or without a multi-line display; a personal communications system (PCS) terminal that may combine a cellular radiotelephone with data processing, facsimile and data communications capabilities; a PDA that may include a radiotelephone, pager, Internet/Intranet access, Web browser, organizer, calendar and/or a global positioning system (GPS) receiver; a laptop and/or palmtop receiver; or other appliances that include a radiotelephone transceiver. Mobile communication device 100 may also include media playing capability. As described above, systems and/or methods described herein may also be implemented in other devices that require user input, with or without communication functionality.

Referring to FIG. 1, mobile communication device 100 may include a housing 110, a speaker 120, a microphone 130, a display 140, control buttons or keys 150, and a keypad 160. Additionally, mobile communication device 100 may include an accessory jack 170 and may be connected to an accessory device 180.

Housing 110 may protect the components of mobile communication device 100 from outside elements. Housing 110 may include a structure configured to hold devices and components used in mobile communication device 100, and may be formed from a variety of materials. For example, housing 110 may be formed from plastic, metal, or a composite, and may be configured to support speaker 120, microphone 130, display 140, control buttons 150, keypad 160, and/or accessory jack 170.

Speaker 120 may provide audible information to a user of mobile communication device 100. Speaker 120 may be located in an upper portion of mobile communication device 100, and may function as an ear piece when a user is engaged in a communication session using mobile communication device 100. Speaker 120 may also function as an output device for music and/or audio information associated with games, voicemails, and/or video images played on mobile communication device 100.

Microphone 130 may receive audible information from the user. Microphone 130 may include a device that converts speech or other acoustic signals into electrical signals for use by mobile communication device 100. Microphone 130 may be located proximate to a lower side of mobile communication device 100.

Display 140 may provide visual information to the user. Display 140 may be a color display, such as a red, green, blue (RGB) display, a monochrome display or another type of display. In one implementation, display 140 may include a touch sensor display or a touch screen that may be configured to receive a user input when the user touches display 140. For example, the user may provide an input to display 140 directly, such as via the user's finger, or via other input objects, such as a stylus. User inputs received via display 140 may be processed by components and/or devices operating in mobile communication device 100. The touch screen display may permit the user to interact with mobile communication device 100 in order to cause mobile communication device 100 to perform one or more operations. In one exemplary implementation, display 140 may include a liquid crystal display (LCD) display. Display 140 may include a driver chip (not shown) to drive the operation of display 140.

Control buttons 150 may permit the user to interact with mobile communication device 100 to cause mobile communication device 100 to perform one or more operations, such as place a telephone call, play various media, etc. For example, control buttons 150 may include a dial button, a hang up button, a play button, etc.

Keypad 160 may include a telephone keypad used to input information into mobile communication device 100.

In an exemplary implementation, control buttons 150 and/or keypad 160 may be part of display 140. Display 140, control buttons 150, and keypad 160 may be part of an optical touch screen display. In addition, in some implementations, different control buttons and keypad elements may be provided based on the particular mode in which mobile communication device 100 is operating. For example, when operating in a cell phone mode, a telephone keypad and control buttons associated with dialing, hanging up, etc., may be displayed by display 140. In other implementations, control buttons 150 and/or keypad 160 may not be part of display 140 (i.e., may not be part of an optical touch screen display).

Accessory jack 170 may enable accessory device 180 to be connected to mobile communication device 100. Accessory jack 170 may be any type of electronic (or optical) connector, including any modular connector, such an 8 position 8 contact (8P8C) connector, or a D-subminiature connector; any USB connector, such as a standard USB connector, a Mini-A USB connector, Mini-B USB connector, Micro-A USB connector, or a Micro-B USB connector; any type of audio or video connector, such as a tip and sleeve (TS) audio connector; a tip, ring, sleeve (TRS) audio connector; a tip, ring, ring, sleeve (TRRS) connector; or a tiny telephone (TT) connector; or any proprietary mobile communication device connector.

Accessory device 180 may include any accessory device that can be connected to mobile communication device 100 through accessory jack 170. Accessory device 180 may include an accessory cord 182, an accessory compartment 184, headphone speakers 186, and a microphone 188. Accessory cord 182 may electrically connect accessory device 180 to mobile communication device 100 through accessory jack 170. Accessory cord 182 may include one or more wires surrounded by insulation.

In one implementation, accessory compartment 184 may include one or more sensors, including one or more of a microphone, an accelerometer, a gyroscope, or a piezoelectric sensor. In another implementation, accessory compartment 184 may include control buttons and/or control knobs, including controls for volume, buttons for playing and stopping audio or video tracks, skipping tracks, or skipping forward or backward in a currently playing audio or video track. Headset speakers 186 may output sound from mobile communication device 100 directly into a user's ear. Microphone 188 may input sound into mobile communication device 100.

While accessory device 180 is illustrated and described in the context of a headset with speakers and a microphone, accessory device 180 may be an electronic device that may be connected to mobile communication device 100 or to another electronic device. While accessory device 180 is described above as connecting to mobile communication device 100 through accessory jack 170, it is to be understood that accessory device 180 need not be directly connected to mobile communication device 100. For example, accessory device 180 may be connected to mobile communication device 100 through a wireless connection, such as Bluetooth connection. In a headset with a wireless Bluetooth connection, accessory cord 182 may not be present.

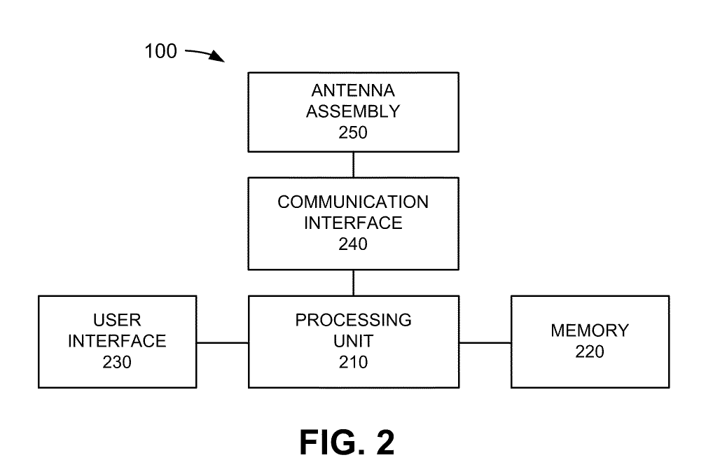

FIG. 2 illustrates a diagram of exemplary components of device 100. As shown in FIG. 2, mobile communication device 100 may include a processing unit 210, a memory 220, a user interface 230, a communication interface 240, and an antenna assembly 250.

Processing unit 210 may include one or more processors, microprocessors, application specific integrated circuits (ASICs), field programmable gate arrays (FPGAs), or the like. Processing unit 210 may control operation of mobile communication device 100 and its components.

Memory 220 may include a random access memory (RAM), a read only memory (ROM), and/or another type of memory to store data and instructions that may be used by processing unit 210.

User interface 230 may include mechanisms for inputting information to mobile communication device 100 and/or for outputting information from mobile communication device 100. Examples of input and output mechanisms might include a speaker (e.g., speaker 120) to receive electrical signals and output audio signals; a camera lens to receive image and/or video signals and output electrical signals; a microphone (e.g., microphone 130) to receive audio signals and output electrical signals; buttons (e.g., a joystick, control buttons 150, or keys of keypad 160) to permit data and control commands to be input into mobile communication device 100; a display (e.g., display 140) to output visual information; and/or a vibrator to cause mobile communication device 100 to vibrate.

Communication interface 240 may include any transceiver-like mechanism that enables mobile communication device 100 to communicate with other devices and/or systems. For example, communication interface 240 may include a modem or an Ethernet interface to a local area network (LAN). Communication interface 240 may also include mechanisms for communicating via a network, such as a wireless network. For example, communication interface 240 may include, for example, a transmitter that may convert baseband signals from processing unit 210 to radio frequency (RF) signals and/or a receiver that may convert RF signals to baseband signals. Alternatively, communication interface 140 may include a transceiver to perform functions of both a transmitter and a receiver. Communication interface 240 may connect to antenna assembly 250 for transmission and/or reception of the RF signals.

Antenna assembly 250 may include one or more antennas to transmit and/or receive RF signals over the air. Antenna assembly 250 may, for example, receive RF signals from communication interface 240 and transmit them over the air and receive RF signals over the air and provide them to communication interface 240. In one implementation, for example, communication interface 240 may communicate with a network (e.g., a local area network (LAN), a wide area network (WAN), a telephone network, such as the Public Switched Telephone Network (PSTN), an intranet, the Internet, or a combination of networks).

As described herein, mobile communication device 100 may perform certain operations in response to processing unit 210 executing software instructions contained in a computer-readable medium, such as memory 220. A computer-readable medium may be defined as a physical or logical memory device. A logical memory device may include memory space within a single physical memory device or spread across multiple physical memory devices. The software instructions may be read into memory 220 from another computer-readable medium or from another device via communication interface 240. The software instructions contained in memory 220 may cause processing unit 210 to perform processes that will be described later. Alternatively, hardwired circuitry may be used in place of or in combination with software instructions to implement processes described herein. Thus, implementations described herein are not limited to any specific combination of hardware circuitry and software.

Although FIG. 2 shows exemplary components of mobile communication device 100, in other implementations, mobile communication device 100 may contain fewer, different, additional, or differently arranged components than depicted in FIG. 2. In still other implementations, one or more components of mobile communication device 100 may perform one or more other tasks described as being performed by one or more other components of mobile communication device 100.

Mobile communication device 100 may provide a platform for a user to make and receive telephone calls, send and receive electronic mail or text messages, play various media, such as music files, video files, multi-media files, or games, and execute various other applications. Mobile communication device 100 may perform these operations in response to processing unit 210 executing sequences of instructions contained in a computer-readable storage medium, such as memory 220. Such instructions may be read into memory 220 from another computer-readable medium or another device via, for example, communication interface 240. In alternative embodiments, hard-wired circuitry may be used in place of or in combination with software instructions to implement processes described herein. Thus, implementations described herein are not limited to any specific combination of hardware circuitry and software.

### Exemplary Tactile Input Device

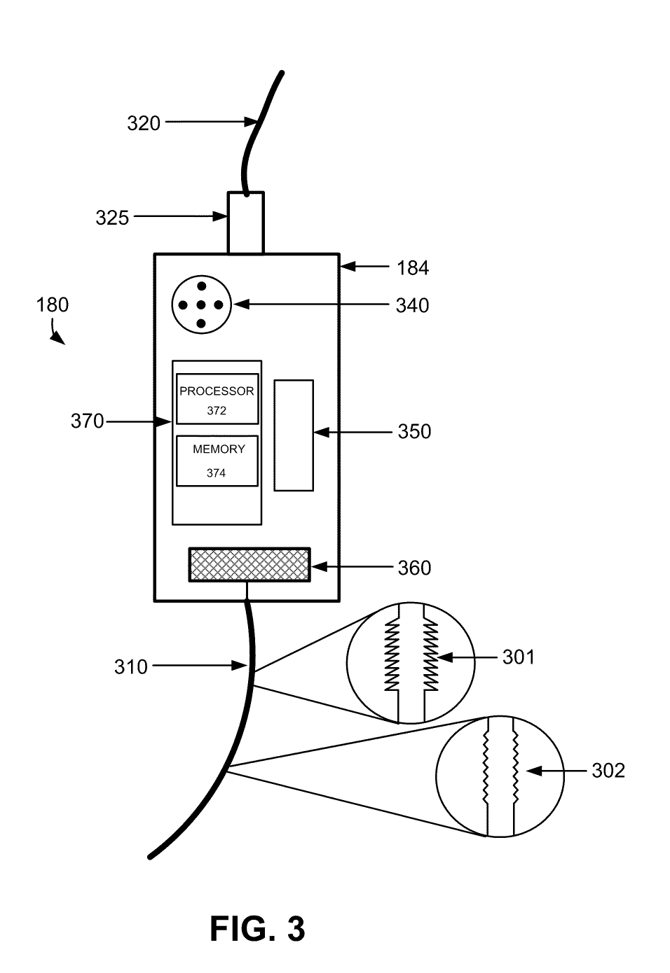

FIG. 3 illustrates a more detailed diagram of accessory device 180. In addition to accessory compartment 184, accessory device 180 may include a first accessory cord 310, a second accessory cord 320, and a connection jack 325.

First accessory cord 310 may be an electrical (or optical) communication cable and may connect accessory compartment 184 to headphone speakers 186 and/or microphone 188, and may include a first textured surface 301 and second textured surface 302. Two textured surfaces are shown for simplicity and first accessory cord 310 may include more or less textured surfaces. First textured surface 301 and second textured surface 302 may function as part of an input device and may be thought of as analogous to buttons or control knobs. A user may scratch, rub, or otherwise contact first textured surface 301 and second textured surface 302 with a finger, fingernail, or an object to activate functions of accessory device 180 or functions of mobile communication device 100. Each textured surface provided on first accessory cord 310 may generate a unique vibration pattern when scratched or rubbed by a user's finger, fingernail, or an object. In other words, each particular textured surface may produce a different sound waveform when scratched or rubbed.

In one implementation, second accessory cord 320 may connect accessory compartment 184, via connection jack 325, to mobile communication device 100, via accessory jack 170. Connection jack 325 may be a same type of connection jack as accessory jack 170 or a different type of connector, such as any of the types of connectors listed above with respect to accessory jack 170. In another implementation, accessory device 180 may not include second accessory cord 320 and connection jack 325. For example, accessory device 180 may communicate with mobile communication device 100 through a wireless connection, such as a Bluetooth connection, and therefore accessory device 180 need not be connected to mobile communication device 100 via an electrical cord.

Accessory compartment 184 may include one or more sensors 340-360 and a processing component 370. One or more sensors 340-360 may include a secondary microphone 340, an accelerometer 350, and a piezoelectric sensor 360. Secondary microphone 340 may include any type of microphone sensor, such as a condenser microphone, an electret microphone, a dynamic microphone, or a piezoelectric microphone. Secondary microphone 340 may be provided alternatively to, or additionally to, microphone 188 located near headset speakers 186. In one implementation, microphone 188 may be acoustically isolated from textured surfaces 301 and 302 and may be dedicated to sensing voice input from the user, and secondary microphone 340 may be dedicated to sensing vibrations from textured surfaces 301 and 302. In another implementation, only one microphone may be provided, either microphone 188 or secondary microphone 340. If a single microphone is provided, the single microphone may detect both voice input from the user and vibrations from textured surfaces 301 and 302.

Accelerometer 350 may include a micro-electromechanical system (MEMS) accelerometer for sensing tilt, orientation, or acceleration of accessory device 180. A MEMS accelerometer may include a cantilever beam that may be displaced as a result of vibrations. Therefore, accelerometer 350 may additionally be used to sense vibrations produced when a user contacts textured surfaces 301 and 302.

Piezoelectric sensor 360 may include a film that includes a piezoelectric material. A piezoelectric material may generate an electric signal in response to mechanical stress. An exemplary piezoelectric material may include a piezoelectric polymer material, such as polyvinylidene fluoride (PVDF). Other piezoelectric polymeric materials may be used, such as a copolymer of vinylidene and trifluoroethylene, known as poly(vinylidene-trifluoroethylene), or P(VDF-TrFE), or a copolymer of vinylidene and tetrafluoroethylene, known as poly(vinylidene-tetrafluoroethylene), or P(VDF-TFE). Copolymerizing VDF may improve piezoelectric response by improving the crystallinity of the resulting polymer. A composite piezoelectric material may be used by incorporating piezoelectric ceramic particles into a piezoelectric polymer material. For example, ceramic particles of lead zirconium titanate (Pb[ZrₓT₁₋ₓ]O₃), barium titanate (BaTiO₃), lithium niobate (LiNbO₃), or bismuth ferrite (BiFeO₃) may be used in a matrix of PVDF, P(VDF-TFE), or P(VDF-TrFE), to improve piezoelectric sensitivity. Piezoelectric sensor 360 may be used to sense vibration produced when a user contacts textured surfaces 301 and 302.

Processing component 370 may include a processor 372 and a memory 374. Processing component 370 may receive tactile input from one or more of microphone 188, secondary microphone 340, accelerometer 350, and piezoelectric sensor 360, may analyze the input, and may select one or more functions based on the analyzed input. Processor 372 may include one or more processors, microprocessors, application specific integrated circuits (ASICs), field programmable gate arrays (FPGAs) or the like. Processor 372 may execute software instructions/programs or data structures to control operation of accessory device 180.

Memory 374 may include a random access memory (RAM) or another type of dynamic storage device that may store information and/or instructions for execution by processor 372; a read only memory (ROM) or another type of static storage device that may store static information and/or instructions for use by processor 372; a flash memory (e.g., an electrically erasable programmable read only memory (EEPROM)) device for storing information and/or instructions; and/or some other type of magnetic or optical recording medium and its corresponding drive. Memory 374 may store data used by processor 372 to analyze tactile input from the sensors of accessory device 180. For example, memory 374 may store spectral signatures corresponding to vibrations produced when a user contacts the different textured surfaces of first accessory cord 310.

In one implementation, processing component 370 may be provided within accessory compartment 184. In another implementation, processing component 370 may be provided within mobile communication device 100. For example, processing component 370 may be implemented using processing unit 210 and memory 220.

While accessory device 180 has been described as including secondary microphone 340, accelerometer 350, and piezoelectric sensor 360, accessory device 180 may include fewer or more sensors. Furthermore, alternately or additionally, one or more of secondary microphone 340, accelerometer 350, or piezoelectric sensor 360 may be included within mobile communication device 100. Moreover, processing component 370 may receive tactile input from textured surfaces 301 and 302 using only one of secondary microphone 340, accelerometer 350, and piezoelectric sensor 360; two of secondary microphone 340, accelerometer 350, and piezoelectric sensor 360; or all three of secondary microphone 340, accelerometer 350, and piezoelectric sensor 360. One exemplary implementation may include the use of only piezoelectric sensor 360 to receive tactile input from textured surfaces 301 and 302.

While in the context of FIG. 3 textured surfaces 301 and 302 are illustrated on first accessory cord 310, textured surfaces may be, alternately or additionally, provided on second accessory cord 320, the housing of accessory compartment 184, and/or on a surface of headset 186, or any other surface of accessory device 180.

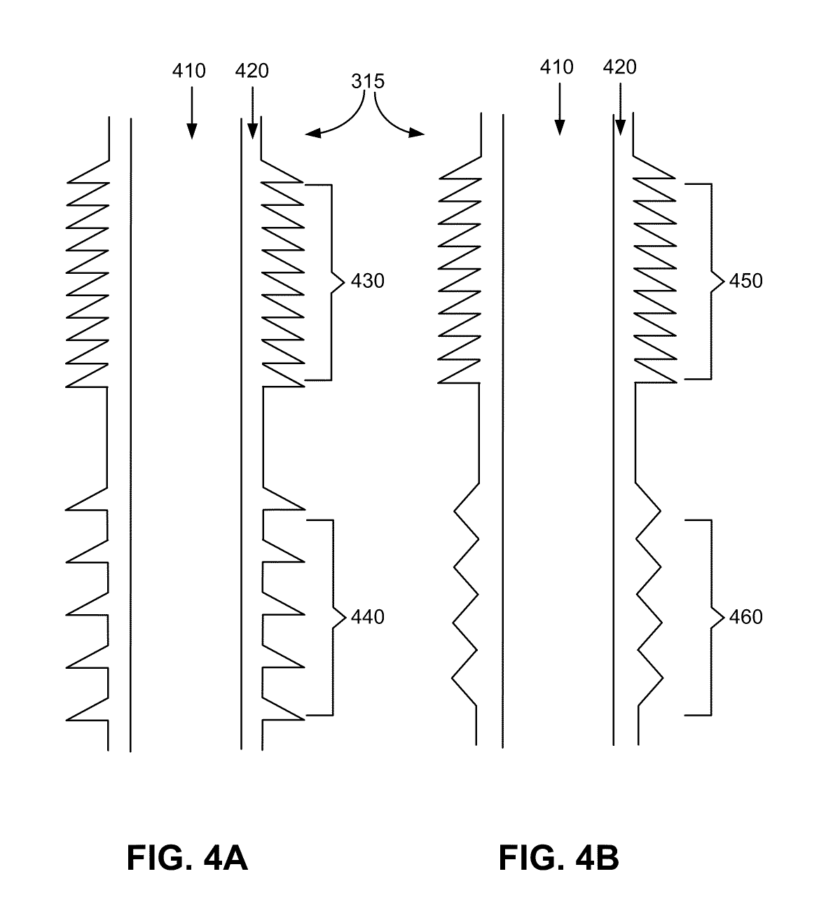

FIG. 4A illustrates exemplary variations in textured surfaces that may be provided on first accessory cord 315. First accessory cord 315 may include a wire 410 and insulation 420. Wire 410 may include one or more metallic wires for conducting electrical signals. Insulation 420 may provide insulation for wire 410 and may include one or more textured surfaces. The textured surfaces may include the same repeating pattern and differ in the density of the repeating pattern. For example, FIG. 4A illustrates insulation 420 with a denser sawtooth pattern 430 and a less dense sawtooth pattern 440. Denser sawtooth pattern 430 may produce vibrations that differ from the vibrations produced by less dense sawtooth pattern 440 when a user scratches or rubs across the textured surface. Processing component 370 may determine whether a user contacted denser sawtooth pattern 430 or less dense sawtooth pattern 440 based on the resulting vibrations.

FIG. 4B illustrates another exemplary variation in textured surfaces that may be provided on first accessory cord 315. The textured surfaces provided on insulation 420 may differ in the shape of the element that makes up the repeating pattern of the textured surface. For example, FIG. 4B illustrates insulation 420 with a sawtooth pattern 450 and a triangular pattern 460. Sawtooth pattern 450 may produce vibrations that differ from the vibrations produced by triangular pattern 460 when a user scratches or rubs across the textured surface. Processing component 370 may determine whether a user contacted sawtooth pattern 450 or triangular pattern 460 based on the resulting vibrations.

First accessory cord 315 may include any combination of textured surfaces that vary in density of the repeating pattern or in the shape of the element that forms the repeating pattern. While textured surfaces 430, 440, 450, and 460 are illustrated as protrusions from the surface of insulation 420, textured surfaces may also be formed as depressions in insulation 420.

Any plastic material may be suitably used for insulation 420, as long as the material is electrically insulating and has the high elasticity required of a flexible cord. The material used may be the same material used for existing insulation in accessory cords. Typical materials that may be used for insulating wires may include polyethylene, polyvinylchloride, polyamide, polybutylene terephthalate, thermoplastic elastomers, ethylene propylene copolymers, polypropylene, or fluoropolymers. These polymers may be used because of their cost, electrical insulating properties, flexibility, and durability. In one implementation, cross-linked polyethylene may be used as the material for insulation 420 and textured surfaces 430, 440, 450, or 460.

As most suitable polymer materials may exhibit sufficient sound conduction for implementing the tactile input device described herein, cost of manufacture of insulation 420 and textured surfaces 430, 440, 450, or 460 may be a more important factor than sound conduction properties. Furthermore, conduction of sound through a material may be related to conduction of heat. As metal may be a better conductor of heat than polymers, metal may be a better conductor of sound as well. Therefore, vibrations produced when a user scratches or rubs a textured surface, located on insulation 420, may travel faster through wire 410 and reach sensors 340, 350, or 360 faster than any vibrations traveling through insulation 420. Thus, detection of sound vibration produced by contact with textured surfaces 430, 440, 450, or 460 may occur to a greater extent via wire 410.

The textured surfaces may be created in insulation 420 using any of a number of manufacturing processes. Coating of wires with insulation may be generally accomplished using a crosshead extrusion process. The wire to be coated may be passed through molten plastic and then through a crosshead die, thereby coating the wire with the plastic to a constant thickness. In one implementation, textured surfaces may be created in insulation 420 during the extrusion process. For example, a die that can vary in diameter may be used, and the die may oscillate in diameter as the wire is drawn through the die. By controlling the speed at which the wire is drawn through the die and the speed at which the diameter of the die changes, textured surfaces of different shapes and different densities of texture may be produced.

In another implementation, the textured surfaces may be created in insulation 420 after the extrusion process. For example, insulation 420 may be heated and placed into a forging die, thereby stamping the textured surface onto insulation 420. The textured surfaces may also be created using etching processes or through a micro-machining process, such as laser machining.

Sensors 340, 350, or 360 may be coupled to first accessory wire 310 in a manner to maximize sound conduction from textured surfaces 430, 440, 450, or 460 to sensors 340, 350, or 360. For example, piezoelectric sensor 360 may be located at a point where first accessory wire 310 enters accessory compartment 184, and the flexible membrane of piezoelectric sensor 360 may directly contact insulation 420. As another example, accelerometer 350 may be mounted directly to the housing of accessory compartment 184, thereby being able to detect sounds vibration that travel from insulation 420 into the housing of accessory compartment 184.

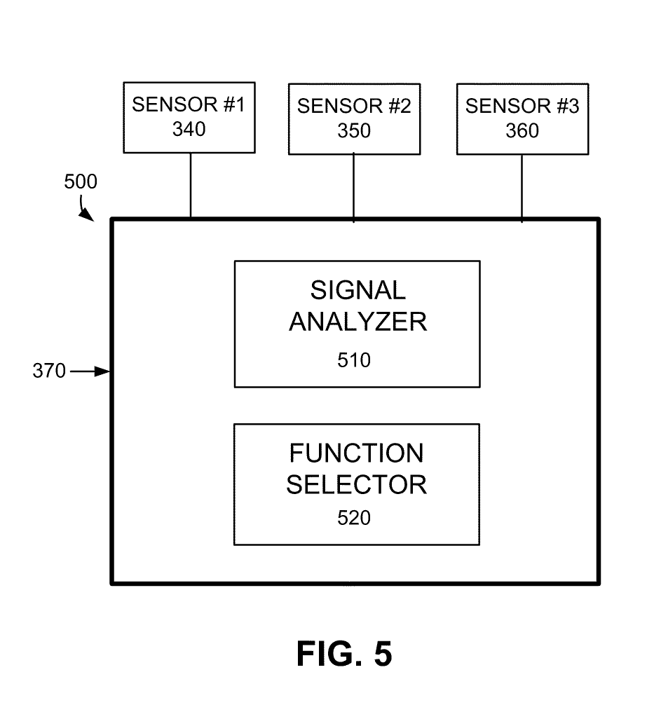

FIG. 5 illustrates an exemplary tactile device 500 according to the system and methods described herein. Tactile input device 500 may include one or more sensors, such as secondary microphone 340, accelerometer 350, or piezoelectric sensor 350, and processing component 370. Processing component 370 may include a signal analyzer 510 and a function selector 520.

Signal analyzer 510 may receive signals from the one or more sensors and analyze the signals to determine which textured surface generated a particular signal. Each textured surface on first accessory cord 310 may generate a unique sound vibration signature. Signal analyzer 510 may be trained to recognize different sound vibration signatures and associate the different sound vibration signatures with particular textured surfaces. In one implementation, data corresponding to the different sound vibration signatures may be stored in memory 374 (or in memory 220) associated with signal analyzer 510. For example, signal analyzer 510 may receive signals from the one or more sensors and compare the data from the signals to data stored in the memory using a lookup process. In another implementation, recognition of the different sound vibration signatures may be directly implemented into a processor associated with signal analyzer 510. For example, signal analyzer 510 may include a neural network that has been trained on input from the textured surfaces included on fist accessory cord 310, and may directly output a result of which particular textured surface generated a received signal. Signal analyzer 510 may be trained in association with a particular set of textured surfaces, using, for example, Bayesian inference.

In addition to selecting a particular textured surface associated with a received signal, signal analyzer 510 may also calculate values for one or more parameters associated with the signal. Signal analyzer 510 may calculate a frequency, amplitude, and/or direction for the received signal. When a user scratches or rubs a textured surface with a light pressure, the action may generate a sound vibration signal with a smaller amplitude, and when the user scratches or rubs the textured surface with a heavy pressure, the action may generate a sound vibration signal with a larger amplitude. Similarly, when a user scratches or rubs a textured surface with a slower speed, the action may generate a sound vibration signal with a lower frequency, and when the user scratches or rubs the textured surface with a faster speed, the action may generate a sound vibration signal with a higher frequency. Furthermore, when a user scratches or rubs a textured surface in one direction, the action may generate a first sound vibration signal, and when a user scratches or rubs a textured surface in the other direction, the action may generate a second sound vibration signal that may be different from the first sound vibration signal. To generate signals that vary based on direction, the textured surface may have a pattern that is asymmetrical. For example, textured surface 430 in FIG. 4B, being asymmetrical, may generate a different sound vibration signal based on direction, while textured surface 460, being symmetrical, may generate the same sound vibration signal in both directions. Thus, signal analyzer 510 may compute one or more of a speed value, pressure value, and direction value for the received signal.

Function selector 520 may receive data from signal analyzer 510. For example, function selector 520 may receive an indication of which particular textured surface was contacted by the user, along with the speed, pressure, and direction of the contacting motion. Function selector 520 may select a function associated with the particular textured surface and assign values to one or more parameters of the function. For example, function selector 520 may select a volume function and determine whether to increase or decrease the volume and the degree to which increase or decrease the volume based on the speed and direction of the scratching motion.

In one implementation, signal analyzer 510 and function selector 520 may be integrated into a single unit, such as a single integrated circuit, and located within accessory compartment 184 of accessory device 180. In another implementation, signal analyzer 510 and function selector 520 may be integrated into a single unit, such as a single integrated circuit, and located within mobile communication device 100. For example, signal analyzer 510 and function selector 520 may be implemented using processing unit 210 and memory 220. In yet another implementation, signal analyzer 510 may be located remotely from function selector 520. For example, signal analyzer 510 may be located within accessory compartment 184 of accessory device 180, while function selector 520 may be located within mobile communication device 100.

### Exemplary Processes

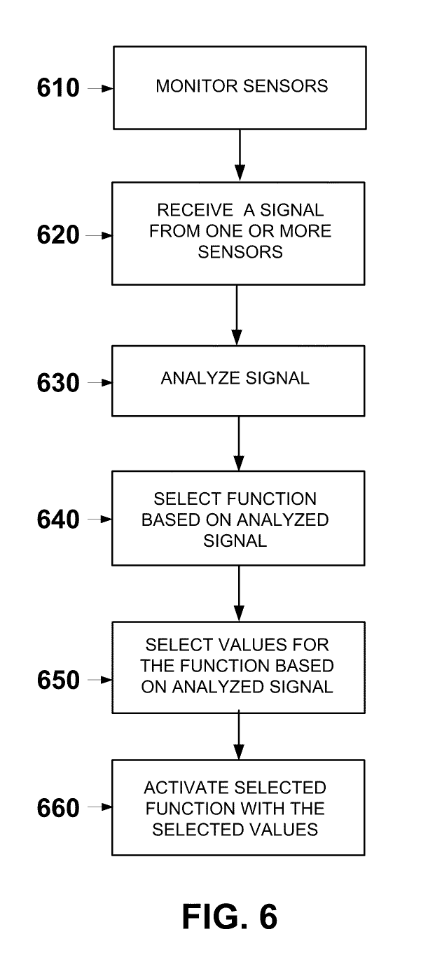

FIG. 6 is a flow diagram illustrating a process for detecting tactile input according to an exemplary implementation. While not shown in FIG. 6, prior to detecting tactile input, textured surfaces of accessory device 180 may be assigned functions executable by either accessory device 180 or mobile communication device 100. The particular functions that are assigned to particular one of the textured surfaces may be set during manufacture of accessory device 180, may be determined by the particular mobile communication device 100 that is connected to accessory device 180, may depend on a particular application being run by mobile communication device 100, or may configurable by the user.

Processing may begin with monitoring of one or more sensors (block 610). For example, signal analyzer 510 may monitor secondary microphone 340, accelerometer 350, and/or piezoelectric sensor 360. A signal from one or more sensors may be received (block 620). If more than one sensor is being used to detect sound vibrations from the textured surfaces of an accessory device, in one implementation signal analyzer 510 may select which sensor may be used to obtain the signal. For example, signal analyzer 510 may select the sensor which has provided the strongest signal, or the signal with the least amount of noise. In another implementation, signal analyzer 510 may obtain signals from more than one sensor and, after normalization of the signals, may average the signals into a combined signal.

The received signal may be analyzed (block 630). Analyzing the signal may include any preprocessing necessary, such as performing a Fourier transform, or another kind of transform. The particular preprocessing of the signal may depend on the particular implementation of signal analysis. Analyzing the signal may include determining a spectral signature for the signal and determining which textured surface of the accessory device produced the signal. For example, signal analyzer 510 may compare the received signal with stored spectral signatures to determine which textured surface produced the signal. Analyzing the signal may further include computing one or more values for the signal. For example, signal analyzer 510 may compute a pressure and speed of the movement associated with the signal, based on the amplitude and frequency for the signal. Signal analyzer 510 may also compute a direction associated with the motion that produced the signal.

A function may be selected based on the analyzed signal (block 640). Each of the textured surfaces may be associated with a function, and the particular function assigned to the particular textured surface, which is associated with the received signal, may be selected. For example, function selector 520 may receive from signal analyzer 510 an indication of which textured surface was scratched or rubbed, along with one or more of the direction, pressure, and speed of the scratching or rubbing motion.

One or more values may be selected for one or more parameters of the function based on the analyzed signal (block 650). The one or more parameters of the function may control the degree or intensity of the function along a continuum spectrum or along a set of distinct intervals. For example, if the function is volume control, a parameter of the function may be whether to increase or decrease the volume and how much to change the volume. A movement across the textured surface associated with volume control in one direction may correspond to an increase in volume, while a movement across the textured surface in the other direction may correspond to a decrease in volume. A light pressure or a slow movement may correspond to a small increase or decrease in volume, and a heavy or fast movement may correspond to a large increase or decrease in volume.

The selected function may be activated with the selected one or more values (block 660). For example, function selector 520 may send a request to a component or application of accessory device 180 or mobile communication device 100. If the function is volume control, the request may be send to a component that controls speaker 120 of mobile communication device 100 or speakers 186 of accessory device 180.

Any function associated with the use of accessory device 180 or mobile communication device 100 may be activated by one of the textured surfaces of accessory device 180. Such functions may include volume control, skipping forward or backward in an audio or video track, skipping forward to a next track or backward to a previous track, stopping, playing or pausing an audio or video track, controlling the brightness of a screen, zooming in or out of the contents displayed on a screen, zooming in and out of focus with a camera, scrolling through the contents of a screen or through a list of selectable objects, simulating a single click of a pointing device, simulating a double-click of a pointing device, moving a cursor across a screen, entering characters, dialing a number or hanging up a call, canceling an action, highlighting an object on a screen, or selecting an object on a screen.

### Examples

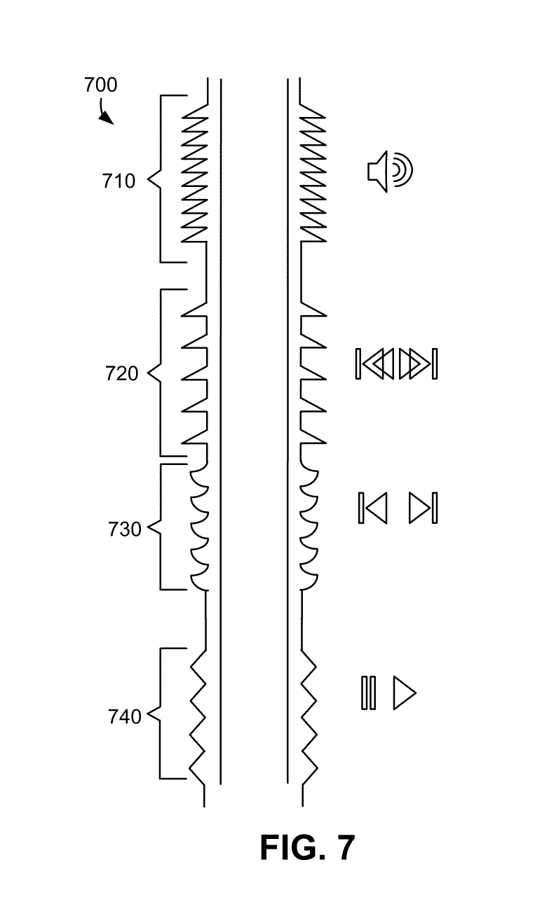

FIG. 7 is a first example of a tactile input device according to implementations described herein. The example of FIG. 7 may be implemented in an accessory cord 700 of a headset for mobile communication device 100 or other portable electronic device, such as a portable music player. Four different textured surfaces may be provided. Accessory cord 700 may include a first textured surface 710, a second textured surface 720, a third textured surface 730, and a fourth textured surface 740.

First textured surface 710 may be associated with volume control and may include an asymmetrical pattern. Control of the volume may be implemented within mobile communication device 100 or within accessory device 180. If a user scratches or rubs up first textured surface 710, the volume may be increase. If a user scratches or rubs down first textured surface 710, the volume may decrease. The speed with which the user rubs first textured surface 710 may determine the degree to which the volume changes. A slow movement may change the volume slightly, while a fast movement may change the volume to a greater degree. Alternately, the degree to which the volume changes may be determined by the pressure applied to first textured surface 710. If the user scratches or rubs first textured surface 710 with a light pressure, the volume may change slightly, and if the user scratches or rubs first textured surface 710 with a heavier pressure, the volume may change to a greater degree.

Second textured surface 720 may be associated with fast forward and reverse control (i.e. skipping ahead or backwards in an audio or video track) and may include an asymmetrical pattern. If a user scratches or rubs up second textured surface 720, the audio or video track that is currently being played may be skipped forward. If a user scratches or rubs down second textured surface 720, the audio or video track that is currently being played may be skipped backward. The speed with which the user rubs second textured surface 720 may determine how far along the track to skip. A slow movement may skip forward or backward a few seconds, while a fast movement may skip forward or backward to a greater degree. Alternately, how far along the track to skip may be determined by the pressure applied to second textured surface 720. If the user scratches or rubs second textured surface 720 with a light pressure, the track may skip a few seconds, and if the user scratches or rubs second textured surface 720 with a heavier pressure, the volume may skip to a greater degree.

Third textured surface 730 may be associated with skipping to the next or previous audio or video track and may include an asymmetrical pattern. If a user scratches or rubs up third textured surface 730, the device may skip to the next track in a play list. If a user scratches or rubs down third textured surface 730, the device may skip to the previous track in a play list.

Fourth textured surface 740 may be associated with playing and stopping an audio or video track, and may include a symmetrical pattern. Thus, the direction in which the user scratches or rubs fourth textured surface may not matter. If a user scratches or rubs fourth textured surface 740, and no audio or video track is being played, the device may start playing an audio or video track. If a user scratches or rubs fourth textured surface 40, and an audio or video track is currently being played, the device may stop playing an audio or video track.

As another implementation of volume control (not shown), the whole range of volume may be mapped onto the entire length, or a portion of the length, of accessory cord 700. For example, assume the volume of a speaker associated with accessory device 180 or mobile communication device 100 may be represented on a scale of 1 to 10, with 10 being the loudest and 1 being essential silent. Ten different textured surfaces may be provided on accessory cord 700, each with a different pattern. A first pattern may correspond to a volume level of 1, a second pattern may correspond to a volume level of 2, and so on until a tenth pattern that may represent a volume level of 10. A user may select a particular volume level by scratching or rubbing a corresponding area of accessory cord 700. Thus, for example, a user may set a maximum volume by scratching an area near the top of accessory cord 700 that may correspond to a volume level of 10, or silence the volume by scratching an area near the bottom of accessory cord 700 that may correspond to a volume level of 1.

Any function associated with a scale may be implemented in a similar fashion. For example, an audio or video track may be mapped onto the length, or a portion of the length, of accessory cord 700. A user may instantly skip to a particular place in the track by scratching on a particular place on the cord. For example, assume an audio or video track is 5 minutes long and accessory cord 700 includes ten different textured surface patterns along the length of the cord. If a user scratches on a first textured surface, the device may skip to the beginning of the track, if the user scratches on a second textured surface, the device may skip a place 30 second into the track, if the user scratches on a third textured surface, the device may skip to place 60 second into the track, etc.

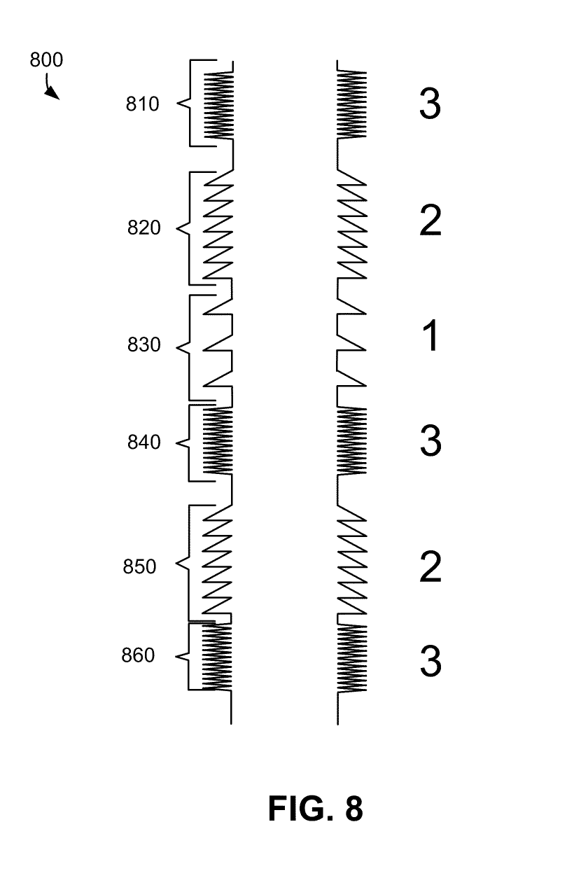

FIG. 8 is a second example of a tactile input device according to implementations described herein. The Example of FIG. 8 may be implemented in an accessory cord 800 of an accessory device, such as a wireless Bluetooth headset device. Multiple different textured surfaces may be provided. Accessory cord 800 may include a first textured surface 810, a second textured surface 820, a third textured surface 830, a fourth textured surface 840, a fifth textured surface 850, and a sixth textured surface 860. The textured surfaces of accessory cord 800 may include different densities of the same pattern. Each particular pattern density may be associated with a value or character, such as a numeral. In the example of FIG. 8, textured surfaces 810, 840, and 860 may represent the numeral 3, textured surfaces 820 and 850 may represent the numeral 2, and textured surface 830 may represent the numeral 1. Together, the textured surfaces of accessory cord 800 may represent a string of numerals, in this example the string “321323,” which may act as an identification code.

The identification code may be used to identify a particular accessory device, and may be used for authentication or device synchronization. For example, a user may turn on the wireless headset and scratch along the series of textured surfaces located on accessory cord 800 of the headset. The identification code associated with the series of textured surfaces may identify the particular model and/or configuration of the wireless headset to the user's mobile communication device. The identification code may also serve as a serial number of the accessory device, and may be used to identify and/or authenticate the user. For example, the identification code may login a user into a network associated with the mobile communication device, or may identify the user when the user wishes to purchase music tracks from a content provider. The identification code may be used instead of, or in addition to, a username and/or a password. For example, it may be more convenient for a user to scratch along accessory cord 800 rather than having to type in a password. In conjunction with a password, an identification code based on a series of textured surfaces may provide an added measure of security.

### Another Exemplary Tactile Input Device

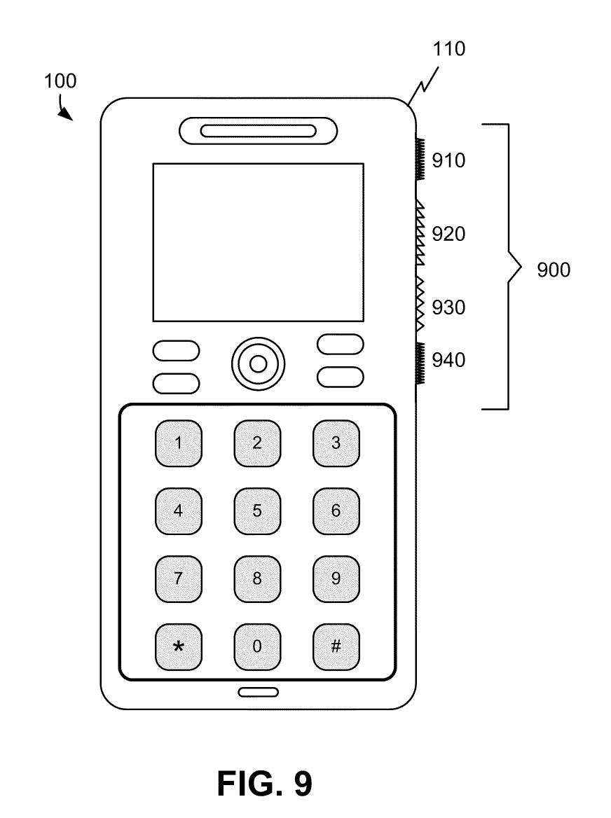

While the examples given above relate to textured surfaces provided on the cord of an accessory device, textured surfaces according to implementations described herein may also be provided directly on mobile communication device 100. FIG. 9 is a diagram of mobile communication device 100 of FIG. 1 equipped with a tactile input device according to implementations described herein. Mobile communication device 100 may include a set of textured surfaces 900. Set of textured surfaces 900 may be provided as part of housing 110. In the example of FIG. 9, set of textured surfaces 900 may include a first textured surface 910, a second textured surface 920, a third textured surface 930, and a fourth textured surface 940. Mobile communication device 100 may include a tactile input device (not shown) analogous to tactile input device 500. That is, in the example of FIG. 9, mobile communication device 100 may include a tactile input device that includes one or more sensors associated with set of textured surfaces 900 (i.e. a microphone, accelerometer, and/or piezoelectric sensor), a signal analyzer component, and a function selector component.

In one implementation, the textured surfaces of FIG. 9 may be associated with functions similar to those described in connection with FIG. 7. For example, first textured surface 910 may be associated with volume control, second textured surface 920 may be associated with skipping forward or backward in a track, third textured surface 930 may be associated with skipping to the next tract or skipping to the previous track, and fourth textured surface 940 may be associated with playing and stopping a track.

In another implementation, the textured surfaces of FIG. 9 may be assigned to functions associated with the screen of display 140. For example, first textured surface 910 may be associated with scrolling up and down the screen, second textured surface 920 may be associated with zooming in and out of the context of the screen, third textured surface 930 may be a two-dimensional surface and may be associated with moving a cursor in X and Y directions in the screen, and fourth textured surface 940 may be associated with a clicking action. In such an implementation, scratching down fourth textured surface 940 may activate a single click, and scratching up fourth textured surface 940 may activate a double click. The functions that are assigned to the textured surfaces of FIG. 9 may be configurable by the user.

In yet another implementation, the textured surfaces of FIG. 9 may be used in conjunction with the textured surfaces of accessory device 180. For example, scratching or rubbing set of textured surfaces 900 may place mobile communication device 100 into synchronization mode. Subsequently, scratching or rubbing a set of textured surface on accessory device 180, such as the set depicted with accessory cord 800 of FIG. 8, may cause mobile communication device 100 to recognize accessory device 180.

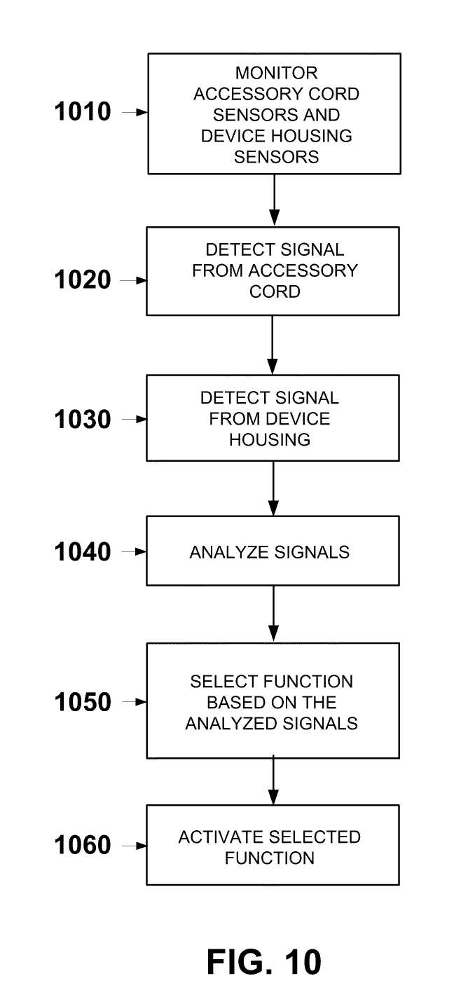

FIG. 10 is a flow diagram illustrating a process for detecting tactile input from a mobile communication device and an accessory device according to an exemplary implementation. Processing may begin with monitoring accessory cord sensors and mobile device housing sensors (block 1010). For example, a signal analyzer component located within mobile communication device 100 may monitor secondary microphone 340, accelerometer 350, and/or piezoelectric sensor 360 associated with accessory device 180 and a microphone, accelerometer, and/or piezoelectric sensor located within mobile communication device 100 and associated with set of textured surfaces 900.

A signal from textured surfaces of an accessory cord may be detected (block 1020). For example, the signal analyzer may detect a signal from one or more sensors associated with the accessory cord. A signal from textured surfaces located in the housing of a device may be detected (block 1030). For example, the signal analyzer may detect a signal from one or more sensors associated with the housing of mobile communication device 100.

The received signal from the accessory cord and the received signal from the housing of the device may be analyzed (block 1040). For example, the signal analyzer may determine which particular textured surface or set of surfaces from the accessory cord was scratched or rubbed, and may also determine which particular textured surface from the set of surfaces of the housing of mobile communication device 100 was scratched or rubbed. A function based on the analyzed signals may be selected (block 1050). For example, a function selector component located within mobile communication device 100 may select a function associated with both the particular textured surface of the accessory cord and the particular textured surface of the device housing.

The selected function may be activated (block 1060). For example, processing unit 210 may activate the selected function. For example, the function may be an identification or synchronization function. If the set of textured surfaces on the accessory cord and the set of textured surface on the housing of mobile communication device 100 are both associated with identification codes, the function may identify accessory device 180 to mobile communication device 100 and/or identify mobile communication device 100 to the accessory device 180. Thus, scratching the set of textured surface of accessory device 180, such as the set of textured surfaces on accessory cord 800 of FIG. 8, and, at substantially the same time, scratching set of textured surfaces 900 on mobile communication device 100, may send the identification code of accessory device 180 to mobile communication device 100. The identification code may be associated with the make and model number of accessory device 180, or even a particular serial number of accessory device 180.

As another example, the selected function may relate to data transfer. For example, accessory device 180 may be a camera. Scratching a particular surface on the camera and, at substantially the same time, scratching a surface on mobile communication device 100 may transfer pictures from the camera to mobile communication device 100.

The selected function may also synchronize a particular function present in both accessory device 180 and mobile communication device 100. For example, both accessory device 180 and mobile communication device 100 may have volume control. Scratching the particular textured surface of accessory device 180 that is associated with volume control, and, at substantially the same time, scratching the particular textured surface of mobile communication device 100 that is associated with volume control, may synchronize the volume control of the two devices. Synchronizing the volume control of the two devices may entail turning off the volume control of one of the devices, so that only one of the devices controls the volume, or adjusting the volume control of both devices to the same scale so that the volume controls of the two devices function identically.

### CONCLUSION

Implementations described here may provide a tactile input device that includes a set of textured surfaces, one or more sensors, and a processing component that analyzes signals generated when a user scratches or rubs one or more of the textured surfaces and selects a function based on which textured surface the user activated. The set of textured surfaces may be provided on any surface of an electronic device, such as on the insulation of a communication cable.

The foregoing description provides illustration and description, but is not intended to be exhaustive or to limit the invention to the precise form disclosed. Modifications and variations are possible in light of the above teachings or may be acquired from practice of the invention.

For example, a set of textured surfaces provided on an accessory cord may be used as a musical instrument. Each particular textured surface may be associated with a distinct sound, such as a particular musical note. By scratching or rubbing the set of textured surfaces, a user may either create a piece of music in real time or compose a piece of music for later listening. As another example, a set of textured surfaces may be used for data entry. Each particular textured surface may be associated with a number, allowing a user to dial a number by scratching or rubbing different areas of an accessory cord. This may be useful if a user is walking with mobile communication device 100 in the user's pocket, and the user does not wish to stop or take mobile communication device 100 out of the user's pocket. Thus, a user may be able to dial a phone number using touch alone.

Furthermore, while series of blocks have been described with respect to FIGS. 6 and 10, the order of the blocks may be modified in other implementations. Further, non-dependent blocks may be performed in parallel.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain aspects described herein may be implemented as “logic” that performs one or more functions. This logic may include hardware, such as a processor, microprocessor, an application specific integrated circuit or a field programmable gate array, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A device, comprising:
one or more textured surfaces, where each of the one or more textured surfaces is associated with a particular function performed by the device;
one or more vibration sensors coupled to the one or more textured surfaces;
a signal analyzer, coupled to the one or more vibration sensors, to:
analyze a signal received from the one or more vibration sensors, and
determine which particular one of the one or more textured surfaces is associated with the analyzed signal; and
a function selector to select the particular function associated with the particular one of the one or more textured surfaces, based on the analyzed signal.

2. The device of claim 1, where the device includes a communication cable and the one or more textured surfaces are located on the communication cable.

3. The device of claim 1, where each of the one or more textured surfaces includes a different pattern, and where scratching or rubbing each of the one or more textured patterns produces a different vibration waveform.

4. The device of claim 3, where at least one of the one or more textured surfaces includes a pattern that produces a first vibration waveform when the pattern is scratched or rubbed in a first direction and produces a second vibration waveform when the pattern is scratched or rubbed in a second direction.

5. The device of claim 1, where the device is an accessory device of a mobile communication device.

6. The device of claim 5, where the accessory device is at least one of:
a stand-alone earpiece with or without a microphone,
headphones with or without a microphone,
a Bluetooth wireless headset,
a cable for connecting to an accessory input in a vehicle,
a charging cable,
a portable speaker,
a camera,
a video recorder,
a radio,
a Universal Serial Bus (USB) port charging and synchronization data cable,
an accessory keyboard, or
a microphone.

7. The device of claim 1, where the signal analyzer component is further to:
calculate at least one value associated with the signal.

8. The device of claim 7, where the at least one value includes at least one of:
a speed with which one of the one or more textured surfaces was scratched or rubbed,
a pressure with which the one of the one or more textured surfaces was scratched or rubbed, or
a direction in which the one of the one or more textured surfaces was scratched or rubbed.

9. The device of claim 1, where the particular function includes at least one of:
volume control,
skipping forward or backward in an audio or video track,
skipping to a next audio or video track or skipping to a previous audio or video track, or
playing and stopping an audio or video track.

10. The device of claim 9, where the particular function includes volume control, and where scratching or rubbing the particular one of the one or more textured surfaces in a first direction increases the volume, and where scratching or rubbing the particular one of the one or more textured surfaces in a second direction decreases the volume.

11. The device of claim 9, where the particular function includes volume control, and where at least one of a pressure or speed with which the particular one of the textured surfaces is scratched or rubbed determines a degree of volume change.

12. The device of claim 1, where the one or more textured surfaces represent an identification code that identifies the device.

13. The device of claim 1, where the one or more vibration sensors include at least one of:
a microphone,
an accelerometer, or
a piezoelectric sensor.

14. A method performed by an electronic device, the method comprising:
receiving, by one or more sensors associated with the electronic device, a vibration signal from one or more textured surfaces;
analyzing, by a processor of the electronic device, the received signal;
determining, by the processor, a particular one of the one or more textured surfaces associated with the received signal;
selecting, by the processor, a particular function assigned to the particular one of the one or more textured surfaces.

15. The method of claim 14, further comprising:
calculating at least one value associated with the received signal.

16. The method of claim 15, where the at least one value represents at least one of:
a speed with which one of the one or more textured surfaces was scratched or rubbed,
a pressure with which the one of the one or more textured surfaces was scratched or rubbed, or
a direction in which the one of the one or more textured surfaces was scratched or rubbed.

17. The method of claim 14, where the particular function includes at least one of:
volume control,
skipping forward or backward in an audio or video track,
skipping to a next audio or video track or skipping to a previous audio or video track,
playing and stopping an audio or video track,
controlling a brightness of a screen of the electronic device,
zooming in or out of contents displayed on the screen,
zooming in and out of focus with a camera of the electronic device,
scrolling through contents of the screen or through a list of selectable objects,
simulating a single click of a pointing device,
simulating a double-click of a pointing device,
moving a cursor across the screen,
entering characters,
dialing a number or hanging up a call,
canceling an action,
highlighting an object on the screen, or
selecting an object on the screen.

18. The method of claim 14, further comprising:
receiving, by the one or more sensors associated with the electronic device, a second vibration signal from one or more second textured surfaces of a second electronic device; and
where the analyzing further comprises analyzing the second vibration signal.

19. The method of claim 18, further comprising:
performing an identification or synchronization operation associated with the electronic device and the second electronic device, based on the analyzed signal.

20. A system comprising:
means for assigning a different function to each of a set of textured surfaces located on a communication cable associated with the system, where each of the set of textured surfaces comprises a different pattern;
means for receiving a vibration signal from the set of textured surfaces;
means for determining which particular one of the set of textured surfaces generated the vibration signal;
means for determining at least one of a direction, a speed, or a pressure associated with a motion that generated the vibration signal; and
means for selecting the function assigned to the particular one of the set of textured surfaces and for selecting a value associated with the selected function based on the at least one of a direction, a speed, or a pressure.
